(19) United States
(12) Patent Application Publication
(10) Pub. No.: US 2025/0353354 A1
(43) Pub. Date: Nov. 20, 2025

(54) VEHICLE AIR CONDITIONING SYSTEM

(71) Applicant: NGK INSULATORS, LTD., Nagoya-City (JP)

(72) Inventors: Hirotaka SAITO, Konan-Shi (JP); Takafumi HAMADA, Nagoya-Shi (JP)

(73) Assignee: NGK INSULATORS, LTD., Nagoya-City (JP)

(21) Appl. No.: 19/089,193

(22) Filed: Mar. 25, 2025

(30) Foreign Application Priority Data
May 16, 2024 (JP) 2024-080388

(51) Int. Cl. B60H 1/00; F24F 6/00

(52) U.S. Cl. CPC B60H 1/00885; B60H 1/00828; F24F 6/00

(57) ABSTRACT

A vehicle air conditioning system includes: an air conditioning duct through which air from a vehicle interior or a vehicle exterior can flow; a ventilation fan disposed in the air conditioning duct; and a humidity controlling device including: a honeycomb structure having an outer peripheral wall and partition walls disposed on an inner side of the outer peripheral wall, the partition walls defining a plurality of cells, each of the cells extending from a first end face to a second end face to form a flow path for the air; and a moisture absorbing layer formed on each surface of the partition walls, the humidity controlling device being disposed in the air conditioning duct on a downstream side of the ventilation fan.

### CROSS REFERENCE TO RELATED APPLICATIONS

The present invention claims the benefit of priority to Japanese Patent Application No 2024-080388 filed on May 16, 2024 with the Japanese Patent Office, the entire contents of which are incorporated herein by reference in its entirety.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Examples of specific requirements include humidity control of the vehicle interior, and the like. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

To address the above problem, Patent Literature 1 proposes a vehicle air conditioning system (vehicle air purifying system) including: a first flow path having a first heating device, a first adsorption block and a first flow path switching mechanism, the first flow path being in communication with a vehicle interior; a second flow path having a second heating device, a second adsorption block and a second flow path switching mechanism, the second flow path being in communication with the vehicle interior; a blower for circulating air from the vehicle interior; an air distribution mechanism for distributing the air flowing from the vehicle interior into the first flow path and the second flow path; and a control device for controlling each component at timing capable of suppress the flow of the air from the flow path on a side where substances to be purified are adsorbed or desorbed toward the vehicle interior when switching the flow path for the air that has passed through the first adsorption block and the air that has passed through the second adsorption block.

In the vehicle air conditioning system of Patent Literature 1, the adsorption blocks are disposed in the two flow paths (first and second flow paths), the flow paths are branched on a downstream side of the adsorption blocks, and valves (air distribution mechanisms) in the branches of each flow path are provided. Although the vehicle air conditioning system having such a configuration can reliably remove substances to be purified such as water vapor (moisture) by alternately adsorbing them with the adsorption block disposed in each flow path, the system size becomes large due to increased numbers of flow paths (pipes) and valves. Further, the air flowing through each flow path must always pass through the adsorption blocks, so that the load on the ventilation fan will be increased, which will be a factor for increased power consumption.

The present invention was made to solve the problems as described above. An object of the present invention is to provide a vehicle air conditioning system capable of reducing the size of the system and of saving power while maintaining its humidity control function.

### PRIOR ART

### Patent Literature

[Patent Literature 1] Japanese Patent Application Publication No. 2020-104774 A

### SUMMARY OF THE INVENTION

As a result of extensive studies for vehicle air conditioning systems having humidity controlling devices, the present inventors have found that by using a specific structure, it is possible to ensure humidity control functionality without having to provide a humidity controlling device in each flow path, which in turn makes it possible to reducing the size and save power. In other words, the invention is exemplified as follows:
<1> A vehicle air conditioning system, comprising:
   an air conditioning duct through which air from a vehicle interior or a vehicle exterior can flow;
   a ventilation fan disposed in the air conditioning duct; and
   a humidity controlling device comprising: a honeycomb structure having an outer peripheral wall and partition walls disposed on an inner side of the outer peripheral wall, the partition walls defining a plurality of cells, each of the cells extending from a first end face to a second end face to form a flow path for the air; and a moisture absorbing layer formed on each surface of the partition walls, the humidity controlling device being disposed in the air conditioning duct on a downstream side of the ventilation fan,
wherein:
   the air conditioning duct is branched on a downstream side of the ventilation fan into a first flow path with the humidity controlling device and a second flow path without the humidity controlling device,
   the first flow path is further branched into a third flow path for allowing the air to flow into the vehicle interior, and a fourth flow path for allowing the air to be discharged to the vehicle exterior,
   the second flow path is provided with a second valve capable of adjusting an amount of the air flowing therein, and
   a branched portion of the third flow path and the fourth flow path is provided with a third valve capable of switching the flow of the air between the third flow path and the fourth flow path.
<2> The vehicle air conditioning system according to <1>, wherein the first flow path is provided with a first valve capable of adjusting an amount of the air flowing therein, on an upstream side of the humidity controlling device.
<3> The vehicle air conditioning system according to <2>, further comprising a control unit capable of controlling the first valve, the second valve, and the third valve.
<4> The vehicle air conditioning system according to <3>, wherein the control unit controls opening degrees of the first valve and the second valve during a moisture adsorption mode and a regeneration mode of the humidity controlling device.
<5> The vehicle air conditioning system according to <4>, wherein, when a flow rate of the air generated by the ventilation fan is 3 m³/min or less, the control unit controls a ratio of the opening degree of the second valve to the opening degree of the first valve to 0.5 or less.
<6> The vehicle air conditioning system according to <4> or <5>, wherein, when a flow rate of the air generated by the ventilation fan is more than 3 m³/min, the control unit controls a ratio of the opening degree of the second valve to the opening degree of the first valve to 0.3 or more.
<7> The vehicle air conditioning system according to any one of <1> to <6>, wherein a minimum cross-sectional area of the second flow path is larger than that of the first flow path, and the minimum cross-sectional area of the fourth flow path is smaller than that of the third flow path.
<8> The vehicle air conditioning system according to <7>, wherein the minimum cross-sectional area of the second flow path is 2 times or more the minimum cross-sectional area of the third flow path.
<9> The vehicle air conditioning system according to <7> or <8>, wherein the minimum cross-sectional area of the third flow path is 4 times or more the minimum cross-sectional area of the fourth flow path.
<10> The vehicle air conditioning system according to any one of <1> to <9>, wherein at least the partition walls of the honeycomb structure are made of a material having a PTC property.
<11> The vehicle air conditioning system according to any one of <1> to <10>, wherein the air conditioning device further comprises a pair of electrodes provided on the first end face and the second end face of the honeycomb structure, or on the outer peripheral wall parallel to an extending direction of the cells of the honeycomb structure.

### BRIEF DESCRIPTION OF THE DRAWINGS

FIG. 1 is an overall schematic configuration view of a vehicle air conditioning system according to Embodiment 1 of the present invention;

FIG. 2A is a schematic view of a cross section parallel to a flow path direction of a humidity controlling device used for a vehicle air conditioning system according to an embodiment of the present invention;

FIG. 2B is a schematic cross-sectional view of the humidity controlling device taken along the line a-a′ in FIG. 2A; and

FIG. 3 is an overall schematic configuration view of a vehicle air conditioning system according to Embodiment 2 of the present invention.

### DETAILED DESCRIPTION OF THE INVENTION

The vehicle air conditioning system according to the present invention includes: an air conditioning duct through which air from a vehicle interior or a vehicle exterior can flow; a ventilation fan disposed in the air conditioning duct; and a humidity controlling device including: a honeycomb structure having an outer peripheral wall and partition walls disposed on an inner side of the outer peripheral wall, the partition walls defining a plurality of cells, each of the cells extending from a first end face to a second end face to form a flow path for the air; and a moisture absorbing layer formed on each surface of the partition walls, the humidity controlling device being disposed in the air conditioning duct on a downstream side of the ventilation fan. The air conditioning duct is branched on a downstream side of the ventilation fan into a first flow path with the humidity controlling device and a second flow path without the humidity controlling device. The first flow path is further branched into a third flow path for allowing the air to flow into the vehicle interior, and a fourth flow path for allowing the air to be discharged to the vehicle exterior. The second flow path is provided with a second valve capable of adjusting an amount of the air flowing therein. A branched portion of the third flow path and the fourth flow path is provided with a third valve capable of switching the flow of the air between the third flow path and the fourth flow path. The vehicle air conditioning system having such a configuration does not require the humidity controlling device in the second flow path because the humidity control function can be sufficiently ensured by the humidity controlling device disposed in the first flow path. This reduces the number of flow paths and valves as well as the load on the ventilation fan, thus enabling downsizing and power savings.

The terms “upstream side” and “downstream side” as used herein are based on the flow of the air flowing through the vehicle air conditioning system.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### Embodiment 1

The vehicle air conditioning system according to Embodiment 1 of the present invention can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The vehicle air conditioning system according to Embodiment 1 of the present invention can be particularly suitably used for a vehicle having no internal combustion engine such as electric vehicles and electric rail cars.

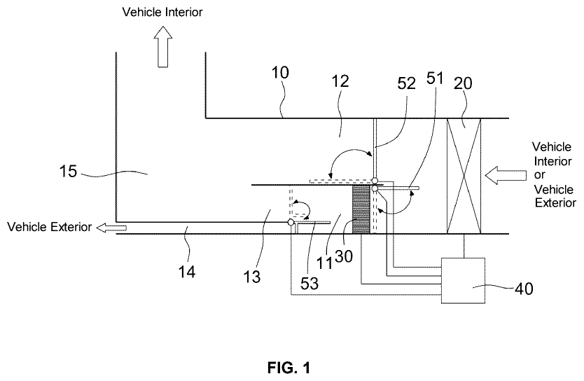

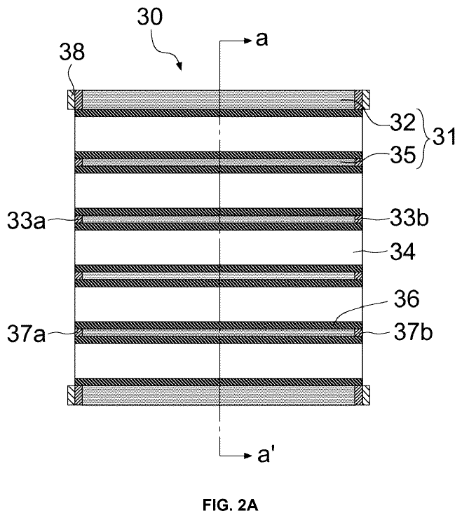

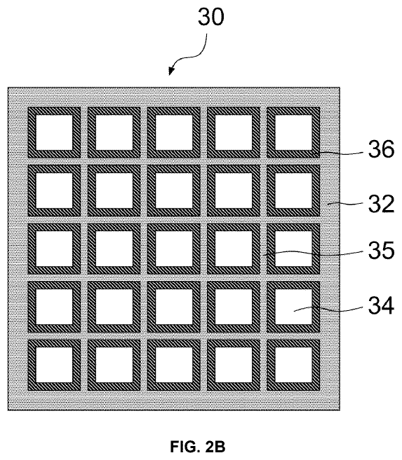

FIG. 1 is an overall schematic configuration view of a vehicle air conditioning system according to Embodiment 1 of the present invention; FIG. 2A is a schematic view of a cross section parallel to a flow path direction of a humidity controlling device used for a vehicle air conditioning system according to Embodiment 1 of the present invention. FIG. 2B is a schematic cross-sectional view of the humidity controlling device in FIG. 2A taken along the line a-a′.

As shown in FIG. 1, the vehicle air conditioning system according to an embodiment of the present invention includes: an air conditioning duct 10; a ventilation fan 20; a humidity controlling device 30; and a control unit 40.

The air conditioning duct 10 can allow air from the vehicle interior or the vehicle exterior to flow therethrough. The air conditioning duct 10 is branched on a downstream side of the ventilation fan 20 into a first flow path 11 with the humidity controlling device 30 and a second flow path 12 without the humidity controlling device 30.

The first flow path 11 is further branched into a third flow path 13 for allowing air to flow into the vehicle interior, and a fourth flow path 14 for allowing the air to be discharged to the vehicle exterior.

The third flow path 13 merges on a downstream side with the second flow path 12 to form a fifth flow path 15 that returns to the vehicle interior. The fifth flow path 15 may be provided with known components (not shown) used for heating and cooling, such as evaporators and condensers, if necessary.

The first flow path 11 on the upstream side of the humidity controlling device 30 is provided with a first valve 51. The first valve 51 is a valve that can adjust an amount of air flowing into the humidity controlling device 30. The first valve 51 is not limited as long as it has the above functions, and any known valve such as a tamper valve and butterfly valve can be used.

The second flow path 12 is provided with a second valve 52. The second valve 52 is a valve that can adjust the amount of air flowing into the second flow path 12. The position of the second valve 52 is not limited as long as it is in the second flow path 12 and may be on an upstream side or a downstream side of the second flow path 12. The second valve 52 is not limited as long as it has the above functions, and any known valve such as a tamper valve or butterfly valve can be used.

A branched portion of the third flow path 13 and the fourth flow path 14 is provided with a third valve 53. The third valve 53 is a valve capable of switching the flow of the air between the third flow path 13 and the fourth flow path 14. The third valve 53 is not limited as long as it has the above functions, and any known valve can be used. Specifically, the third valve 53 may be electrically driven and have the function of switching the flow path, and a solenoid valve, an electric valve, and the like can be used. For example, the third valve 53 includes an opening/closing door supported by a rotating shaft and an actuator such as a motor that rotates the rotating shaft. The actuator can be configured to be controllable by the control unit 40.

The humidity controlling device 30 is disposed in the air conditioning duct 10 (specifically in the first flow path 11) on the downstream side of the ventilation fan 20. The number of humidity controlling devices 30 disposed in the air conditioning duct 10 may be one or more. When multiple humidity controlling devices 30 are provided, they may be arranged in parallel or in series with respect to the flow of the air flowing through the air conditioning duct 10.

As shown in FIGS. 2A and 2B, the humidity controlling device 30 includes: a honeycomb structure 31 having an outer peripheral wall 32 and partition walls 35 disposed on an inner side of the outer peripheral wall 32, the partition walls 35 defining a plurality of cells 34 each extending from a first end face 33a to a second end face 33b to form a flow path for air; and a moisture absorbing layer 36 formed on a surface of each of the partition wall 35. The honeycomb structure 31 can further include: a pair of electrodes 37a, 37b; and terminals 38 connected to the pair of electrodes 37a, 37b.

The control unit 40 can control the ventilation fan 20 and the humidity controlling device 30, as well as each valve (the first valve 51, the second valve 52 and the third valve 53). Specifically, the control unit 40 is electrically connected to the ventilation fan 20, the humidity controlling device 30, and each valve, and can control the ventilation fan 20, the humidity controlling device 30, and each valve based on instructions from the control unit 40. In particular, the ventilation fan 20 can adjust the rotation speed of the ventilation fan 20 according to the instructions from the control unit 40, thereby controlling the flow rate of the air flowing through the air conditioning duct 10.

The vehicle air conditioning system having the above structure can dehumidify the air in the vehicle interior by allowing the air to flow through the first flow path 11 to reduce moisture in the air in the humidity controlling device 30 and allowing that air to flow into the third flow path 13. The mode of the humidity controlling device 30 at this time is referred to as a “moisture absorption mode”.

The humidity controlling device 30 can be regenerated by heating the humidity controlling device 30 while allowing the air to flow through the first flow path 11 to separate the moisture adsorbed by the humidity controlling device 30 and discharging the air containing the moisture to the vehicle exterior through the fourth flow path 14. The mode of the humidity controlling device 30 at this time is referred to as a “regeneration mode”.

Furthermore, the air can be blown into the vehicle interior by allowing the air to flow through the second flow path 12.

The control unit 40 can control the opening degrees of the first valve 51 and the second valve 52 during the dehumidification mode and the regeneration mode of the humidity controlling device 30. By controlling the opening degrees of the first valve 51 and the second valve 52, the air can be allowed to flow into the vehicle interior while allowing the air at a flow rate suitable for each mode to flow through the humidity controlling device 30.

The “opening degree” of each valve as used herein means a cross-sectional area of a passage through which the air flows, expressed as a percentage, when the cross-sectional area of the passage through which the air flows during full opening of each valve is 100%.

When a flow rate of the air generated by the ventilation fan 20 is 3 m³/min or less, the control unit 40 controls a ratio of the opening degree of the second valve 52 to the opening degree of the first valve 51 to 0.5 or less. By controlling the ratio of the opening degree within this range, it is possible to allow the air at an appropriate flow rate to flow through the first flow path 11. Therefore, the adsorption (dehumidification) process by the humidity controlling device 30 and the regeneration process of the humidity controlling device 30 can be easily performed. In particular, the above control during the regeneration process of the humidity controlling device 30 can increase the efficiency of the regeneration process of the humidity controlling device 30.

The lower limit of the ratio of the opening degree in this case is not limited and it may be zero (in the state where the second valve 52 has been closed).

When the flow rate of the air generated by the ventilation fan 20 is more than 3 m³/min, the control unit 40 preferably controls the ratio of the opening degree of the second valve 52 to the opening degree of the first valve 51 to 0.3 or more. By controlling the ratio of the opening degree within this range, it is possible to allow an appropriate flow rate of the air to flow through the first flow path 11. Therefore, the adsorption (dehumidification) process by the humidity controlling device 30 and the regeneration process of the humidity controlling device 30 can be easily performed. In particular, the above control during the adsorption process by the humidity controlling device 30 can increase the efficiency of the adsorption process by the humidity controlling device 30.

The upper limit of the ratio of the opening degree in this case is not limited and it may typically be 1.0 or less, and preferably 0.8 or less.

Each component of the vehicle air conditioning system 100 will be described below in detail.

### 1. Air Conditioning Duct 10

The air conditioning duct 10 is a flow path through which air can flow. As described above, the air conditioning duct 10 includes the first flow path 11, the second flow path 12, the third flow path 13, the fourth flow path 14 and the fifth flow path 15.

The air conditioning duct 10 is preferably made of a metal in terms of manufacturability, although not particularly limited thereto. Examples of the material of the air conditioning duct 10 that can be used herein include stainless steel, titanium alloys, copper alloys, aluminum alloys, brass and the like. Among them, the stainless steel is preferable because it has high durability and reliability and is inexpensive.

### 2. Ventilation Fan 20

The ventilation fan 20 is a device for allowing air from the vehicle interior or the vehicle exterior to flow therethrough. The ventilation fan 20 is not particularly limited, and any commercially available ventilation fan can be used.

The ventilation fan 20 is electrically connected to the control unit 40 and can control the amount of the air by adjusting the rotation speed according to instructions from the control unit 40.

### 3. Humidity Controlling Device 30

### 3-1. Honeycomb Structure 31

The shape of the honeycomb structure 31 is not particularly limited. For example, an outer shape of a cross section of the honeycomb structure 31 orthogonal to the flow path direction (the extending direction of the cells 34) can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 33a and second end face 33b) have the same shape as the cross section. Also, when the cross section and the end faces are polygonal, the corners may be chamfered.

The shape of each cell 34 is not particularly limited, but it may be polygonal such as quadrangular, pentagonal, hexagonal, heptagonal, and octagonal, circular, or oval in the cross section of the honeycomb structure 31 orthogonal to the flow path direction. These shapes may be alone or in combination of two or more. Moreover, among these shapes, the quadrangle or the hexagon is preferable. By providing the cells 34 having such a shape, it is possible to reduce the pressure loss when the air flows.

The honeycomb structure 31 may be a honeycomb joined body having a plurality of honeycomb segments and joining layers that join outer peripheral side surfaces of the plurality of honeycomb segments together. The use of the honeycomb joined body can increase the total cross-sectional area of the cells 34, which is important for ensuring the flow rate of air, while suppressing cracking.

It should be noted that the joining layer can be formed by using a joining material. The joining material is not particularly limited, but a ceramic material obtained by adding a solvent such as water to form a paste can be used.

The joining material may contain a material having the PTC property, or may contain the same material as the outer peripheral wall 32 and the partition walls 35. In addition to the role of joining the honeycomb segments to each other, the joining material can also be used as an outer peripheral coating material after joining the honeycomb segments.

From the viewpoints of ensuring the strength of the honeycomb structure 31, reducing pressure loss when air passes through the cells 34, ensuring the amount of functional material supported, and ensuring the contact area with the air flowing inside the cells 34, it is desirable to suitably combine a thickness of the partition wall 35, a cell density, and a cell pitch (or an opening ratio of the cells 34).

As used herein, the cell density refers a value obtained by dividing a number of cells by an area of one end face (first end face 33a or second end face 33b) of the honeycomb structure 31 (the total area of the partition walls 35 and the cells 34 excluding the outer peripheral wall 32).

As used herein, the cell pitch refers to a value obtained by the following calculation. First, the area of one end face (first end face 33a or second end face 33b) of the honeycomb structure 31 (the total area of the partition walls 35 and the cells 34 excluding the outer peripheral wall 32) is divided by the number of the cells to calculate an area per a cell. A square root of the area per a cell is then calculated, and this is determined to be the cell pitch.

As used herein, the opening ratio of the cells 34 refers a value obtained by dividing the total area of the cells 34 defined by the partition walls 35 by the area of one end face (first end face 33a or second end face 33b) (the total area of the partition walls 35 and the cells 34 excluding the outer peripheral wall 32) in the cross section orthogonal to the flow path direction of the honeycomb structure 31. It should be noted that when calculating the opening ratio of the cells 34, the pair of electrodes 37a, 37b, and the moisture absorbing layer 36 are not taken into account.

In an embodiment that is advantageous from the viewpoint of supporting a sufficient amount of functional material, the thickness of the partition walls 35 is 0.300 mm or less, the cell density is 100 cells/cm² or less, and the cell pitch is 1.0 mm or more. In a preferred embodiment, the thickness of the partition walls 35 is 0.200 mm or less, the cell density is 70 cells/cm² or less, and the cell pitch is 1.2 mm or more. In a more preferred embodiment, the thickness of the partition walls 35 is 0.130 mm or less, the cell density is 65 cells/cm² or less, and the cell pitch is 1.3 mm or more.

From the viewpoints of ensuring the strength of the honeycomb structure 31 and maintaining lower electrical resistance, the lower limit of the thickness of the partition wall 35 is preferably 0.010 mm or more, and more preferably 0.020 mm or more, and even more preferably 0.030 mm or more. From the viewpoints of ensuring the strength of the honeycomb structure 31, maintaining lower electrical resistance, and increasing a surface area to facilitate reaction, adsorption, and release, the lower limit of the cell density is 30 cells/cm² or more, and preferably 35 cells/cm² or more, and even more preferably 40 cells/cm² or more.

From the viewpoints of ensuring the strength of the honeycomb structure 31, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition walls 35 is 0.08 to 0.36 mm, the cell density is 2.54 to 140 cells/cm², and the opening ratio of the cells 34 is 0.70 or more. In a preferred embodiment, the thickness of the partition walls 35 is 0.09 to 0.35 mm, the cell density is 15 to 100 cells/cm², and the opening ratio of the cells 34 is 0.80 or more. In a more preferred embodiment, the thickness of the partition walls 35 is 0.14 to 0.30 mm, the cell density is 20 to 90 cells/cm², and the opening ratio of the cells 34 is 0.85 or more.

From the viewpoint of ensuring the strength of the honeycomb structure 31, the upper limit of the opening ratio of the cells 34 is preferably 0.94 or less, and more preferably 0.92 or less, and even more preferably 0.90 or less.

Although the thickness of the outer peripheral wall 32 is not particularly limited, it is preferably determined based on the following viewpoints. First, from the viewpoint of reinforcing the honeycomb structure 31, the thickness of the outer peripheral wall 32 is preferably 0.05 mm or more, and more preferably 0.06 mm or more, and even more preferably 0.08 mm or more. On the other hand, the thickness of the outer peripheral wall 32 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

As used herein, the thickness of the outer peripheral wall 32 refers to a length from a boundary between the outer peripheral wall 32 and the outermost cell 34 or the partition wall 35 to a side surface of the honeycomb structure 31 in a normal line direction of the side surface in the cross section orthogonal to the flow path direction of the honeycomb structure 31.

The length of the honeycomb structure 31 in the flow path direction and the cross-sectional area orthogonal to the flow path direction may be adjusted according to the required size of the humidity controlling device 30, and are not particularly limited. For example, when used in a compact humidity controlling device 30 while ensuring a predetermined function, the honeycomb structure 31 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 35 forming the honeycomb structure 31 are preferably made of a material that can be heated by electric conduction, specifically made of a material having the PTC property. Further, the outer peripheral wall 32 may also be made of the material having the PTC property, as with the partition walls 35, as needed. By such a configuration, the moisture absorbing layer 36 can be directly heated by heat transfer from the heat-generating partition walls 35 (and optionally the outer peripheral wall 32). Further, the material having the PTC property has characteristics such that when the temperature increases to exceed the Curie point, the resistance value is sharply increased, resulting in a difficult for electricity to flow. Therefore, when the temperature of the partition walls 35 (and the outer peripheral wall 32 if necessary) becomes high, the current flowing through them is limited, thereby suppressing excessive heat generation of the honeycomb structure 31. Therefore, it is possible to suppress thermal deterioration of the moisture absorbing layer 36 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. As used herein, the volume resistivity at 25° C. of the material having the PTC property is measured according to JIS K 6271:2008.

From the viewpoints that can be heated by electric conduction and has the PTC property, the outer peripheral wall 32 and the partition walls 35 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 32 and the partition walls 35 are substantially free of lead (Pb). More particularly, the outer peripheral wall 32 and the partition walls 35 preferably have a Pb content of 0.01% by mass or less, and more preferably 0.001% by mass or less, and still more preferably 0% by mass. The lower Pb content can allow the air heated by contact with the heat-generating partition walls 35 to be safely applied to organisms such as humans, for example. In the outer peripheral wall 32 and the partition walls 35, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The Curie point of the material making up the outer peripheral wall 32 and the partition walls 35 is preferably in a temperature range where the resistance value is twice or more the resistance at room temperature (25° C.). If the Curie point is in such a temperature range, the current flowing through the humidity controlling device 30 will be limited when the temperature of the humidity controlling device 30 becomes high, so that any excessive heat generation of the humidity controlling device 30 will be efficiently suppressed. Therefore, thermal deterioration of the moisture absorbing layer 36 caused by excessive heat generation can be suppressed.

The material making up the outer peripheral wall 32 and the partition walls 35 preferably have a lower limit of a Curie point of 80° C. or more, and more preferably 100° C. or more, and even more preferably 110° C. or more, and still more preferably 125° C. or more, in terms of efficiently heating the moisture absorbing layer 36. Further, the upper limit of the Curie point is preferably 200° C. or more, and preferably 190° C. or more, and even more preferably 180° C. or more, and particularly preferably 150° C. or more, in terms of safety as a component placed in the vehicle interior or near the vehicle interior.

The Curie point of the material making up the outer peripheral wall 32 and the partition walls 35 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### 3-2. Pair of Electrodes 37a, 37b

A pair of electrodes 37a, 37b may be provided on the first end face 33a and the second end face 33b as shown in FIG. 2A, although the positions of the electrodes 37a, 37b are not limited thereto. Also, the pair of electrodes 37a, 37b may be provided on the outer peripheral wall 32 parallel to the extending direction of the cells 34.

Applying of a voltage between the pair of electrodes 37a, 37b allows the honeycomb structure 31 to generate heat by Joule heat.

The pair of electrodes 37a, 37b may employ, for example, a metal or alloy containing at least one selected from Cu, Ag, Al, Ni and Si, although not particularly limited thereto. It is also possible to use an ohmic electrode capable of ohmic contact with the outer peripheral wall 32 and/or the partition walls 35 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 37a, 37b may have a single-layer structure, or may have a laminated structure of two or more layers. When the pair of electrodes 37a, 37b have the laminated structure of two or more layers, the materials of the respective layers may be of the same type or of different types.

The thickness of the pair of electrodes 37a, 37b may be appropriately set according to the method for forming the pair of electrodes 37a, 37b. The method for forming the pair of electrodes 37a, 37b includes metal deposition methods such as sputtering, vapor deposition, electrolytic deposition, and chemical deposition. Alternatively, the pair of electrodes 37a, 37b can be formed by applying an electrode paste and then baking it, or by thermal spraying. Furthermore, the pair of electrodes 37a, 37b may be formed by joining metal sheets or alloy sheets.

Each of the thicknesses of the pair of electrodes 37a, 37b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

### 3-3. Terminal 38

The terminals 38 are connected to the pair of electrodes 37a, 37b, and provided on at least part of the pair of electrodes 37a, 37b. The provision of the terminals 38 facilitates connection to an external power supply. The terminals 38 are connected to a conductor connected to the external power supply.

The terminals 38 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 38 are not particularly limited. For example, as shown in FIG. 2A, the terminals 38 can be provided on the whole of the pair of electrodes 37a, 37b on the outer peripheral wall 32. Further, the terminals 38 may be provided on a part of the pair of electrodes 37a, 37b on the outer peripheral wall 32, or may be provided so as to extend toward an outer side than the outer edge of each of the pair of electrodes 37a, 37b on the outer peripheral wall 32. Further, the terminals 38 may be provided on a part of the pair of electrodes 37a, 37b on the partition walls 35, or may be provided so as to block a part of the cells 34.

Furthermore, the thickness of the terminal 38 is not particularly limited, but it is, for example, 0.01 to 10 mm, typically 0.05 to 5 mm.

The method of connecting the terminals 38 to the pair of electrodes 37a, 37b is not particularly limited as long as they are electrically connected. For example, they can be connected by diffusion bonding, a mechanical pressing mechanism, welding, or the like.

### 3-4. Moisture Absorbing Layer 36

The moisture absorbing layer 36 is a layer having a function of adsorbing moisture (water vapor).

The moisture absorbing layer 36 can be provided on the surfaces of the partition walls 35 (in the case of the outermost cells 34, the partition walls 35 that define the outermost cells 34 and the outer peripheral wall 32). By thus providing the moisture absorbing layer 36, the moisture is easily absorbed during the moisture absorption process, and the moisture absorbing layer 36 can be easily heated during the regeneration process, so that the moisture adsorbing function by the moisture absorbing layer 36 can be regenerated.

The moisture absorbing material contained in the moisture absorbing layer 36 preferably has a function that can adsorb the moisture at −20 to 40° C. and release it at an elevated temperature of 60° C. or more.

Examples of the moisture absorbing material include, but not limited to, aluminosilicate, silica gel, silica, graphene oxide, polymer adsorbents, polystyrene sulfonic acid, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

Examples of the silica gel that can be preferably used herein include type A silica gel.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The moisture absorbing layer 36 is preferably capable of adsorbing carbon dioxide and/or volatile components in addition to moisture. Specifically, the moisture absorbing layer 36 can contain an adsorbent that can adsorb carbon dioxide and/or volatile components, in addition to the moisture absorbing material that can adsorb the moisture. If the moisture adsorbing material that can adsorb the moisture is also capable of adsorbing carbon dioxide and/or volatile components, the carbon dioxide and/or volatile components can be adsorbed in addition to the moisture by including only the moisture adsorbing material. By containing such a adsorbent or using the moisture absorbing material, it is possible to obtain an impact of purifying the air in addition to the effect of dehumidifying the air.

The adsorbent preferably has a function that can adsorb carbon dioxide and/or volatile components at −20 to 40° C. and release them at an elevated temperature of 60° C. or more.

Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The volatile components in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The moisture absorbing layer 36 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the moisture absorbing layer 36 may be determined according to the size of the cells 34, and is not particularly limited. For example, the thickness of the moisture absorbing layer 36 is preferably 20 μm or more, and more preferably 25 μm or more, and even more preferably 30 μm or more, from the viewpoint of ensuring sufficient contact with air. On the other hand, the thickness of the moisture absorbing layer 36 is preferably 400 μm or less, and more preferably 380 μm or less, and even more preferably 350 μm or less, from the viewpoint of suppressing separation of the moisture absorbing layer 36 from the partition walls 35 and the outer peripheral wall 32.

The thickness of the moisture absorbing layer 36 is measured using the following procedure. Any cross section parallel to the flow path direction of the honeycomb structure 31 is cut out, and a cross-sectional image at magnifications of about 50 is acquired using a scanning electron microscope or the like. Also, this cross section is made to pass through the center of gravity position in the cross section orthogonal to the flow path of the honeycomb structure 31. The thickness of each moisture absorbing layer 36 visually recognized from the cross-sectional image is calculated by dividing the cross-sectional area by the length of the cells 34 in the flow path direction. This calculation is performed for all the moisture absorbing layers 36 visually recognized from the cross-sectional image, and an average value thereof is determined to be the thickness of the moisture absorbing layer 36.

From the viewpoint of exerting a desired function in the humidity controlling device 30, an amount of the moisture absorbing layer 36 is preferably 50 to 500 g/L, and more preferably 100 to 400 g/L, and even more preferably 150 to 350 g/L, based on the volume of the honeycomb structure 31. It should be noted that the volume of the honeycomb structure 31 is a value determined by the external dimensions of the honeycomb structure 31.

### 3-5. Method for Producing Humidity Controlling Device 30

The method for producing the humidity controlling device 30 according to the embodiment of the present invention is not particularly limited, and it can be performed according to a known method. Hereinafter, the method for producing the humidity controlling device 30 according to an embodiment of the present invention will be illustratively described.

A method for producing the honeycomb structure 31 forming the humidity controlling device 30 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:
relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430°° C. at a heating rate of 20 to 600° C./hour, and maintaining the temperature for 0.5 to 10 hours.

The maintaining of the honeycomb formed body at the maximum temperature of from 1360 to 1430°° C. for 0.5 to 10 hours can provide the honeycomb structure 31 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 31 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 31.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure 31 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 37a, 37b is formed on the honeycomb structure 31 thus obtained. The pair of electrodes 37a, 37b can be formed by metal deposition methods such as sputtering, vapor deposition, electrolytic deposition, and chemical deposition. Further, the pair of electrodes 37a, 37b can also be formed by applying an electrode paste and then baking it. Furthermore, the pair of electrodes 37a, 37b can also be formed by thermal spraying. The pair of electrodes 37a, 37b may be composed of a single layer, but may also be composed of a plurality of electrode layers having different compositions. A typical method for forming the pair of electrodes 37a, 37b will be described below.

First, an electrode slurry containing an electrode material, an organic binder, and a dispersion medium is prepared, and the first end face 33a or the second end face 33b of the honeycomb structure 31 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 31 is removed by blowing and wiping. The slurry can be then dried to form the pair of electrodes 37a, 37b on the first end face 33a or the second end face 33b of the honeycomb structure 31. The drying can be performed while heating the honeycomb structure 31 to a temperature of about 120 to 600° C., for example. Although a series of steps of coating, slurry removal, and drying may be performed only once, the steps can be repeated multiple times to provide the pair of electrodes 37a, 37b having desired thicknesses.

The terminals 38 are then disposed at predetermined positions of the pair of electrodes 37a, 37b, and the pair of electrodes 37a, 37b and the terminals 38 are connected to each other. As a method of connecting the pair of electrodes 37a, 37b to the terminals 38, the method described above can be used. It should be noted that the terminals 38 may be disposed after forming a moisture absorbing layer 36 described below.

The moisture absorbing layer 36 is then formed on the surfaces of the partition walls 35 and the like of the honeycomb structure 31.

Although the method for forming the moisture absorbing layer 36 is not particularly limited, it can be formed, for example, by the following steps. The honeycomb structure 31 is immersed in a slurry containing a moisture absorbent, an organic binder, and a dispersion medium for a predetermined period of time, and an excess slurry on the end faces and the outer periphery of the honeycomb structure 31 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the moisture absorbing layer 36 on the surfaces of the partition walls 35. The drying can be performed while heating the honeycomb structure 31 to a temperature of about 120 to 600° C., for example. Although a series of steps of immersion, slurry removal, and drying may be performed only once, the steps can be repeated multiple times to provide the moisture absorbing layer 36 having the desired thickness on the surfaces of the partition walls 35 and the like.

### 4. Control Unit 40

The control unit 40 is electrically connected to the ventilation fan 20, the humidify controlling device 30, and each valve (the first valve 51, the second valve 52 and the third valve 53). Between each component and the control unit 40 may be a power source (not shown). The power source is not particularly limited, and a battery or the like can be used.

The control unit 40 can control the power source, thereby adjusting the heating state of the honeycomb structure 31 by controlling a voltage applying state to the pair of electrodes 37a, 37b of the humidity controlling device 30. The control unit 40 can also control the flow of the air by controlling each valve. Furthermore, by adjusting the rotation speed of the ventilation fan 20, the flow rate of the air flowing through the air conditioning duct 10 can be controlled.

The control unit 40 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 40 can execute the dehumidification (moisture absorption) mode, the regeneration mode and an air blowing mode. Hereinafter, each of these modes will be described.

### Dehumidification Mode

In the dehumidification mode, the control unit 40 controls the first valve 51 and the third valve 53 so that the air flows into the first flow path 11, the third flow path 13 and the fifth flow path 15 sequentially. Specifically, the first valve 51 is opened and the first valve 53 is switched such that the air flows through the third flow path 13 and the air does not flow through the fourth flow path 14. By controlling them in this manner, the air flowing in the first flow path 11 can be dehumidified in the humidity controlling device 30 and returned to the vehicle interior via the third flow path 13 and the fifth flow path 15.

In the dehumidification mode, the control unit 40 may control the second valve 52 so that a part of the air flows into the second flow path 12. Such control can suppress excessive dehumidification, thereby optimizing the humidity of the air in the vehicle interior.

### Regeneration Mode

In the regeneration mode, the control unit 40 controls the first valve 51 and the third valve 53 so that the air flows into the first flow path 11 and fourth flow path 14 sequentially. Specifically, the first valve 51 is opened and the first valve 53 is switched such that the air does not flow through the third flow path 13 and the air flows through the fourth flow path 14. The control unit 40 also applies voltage to the humidity controlling device 30 to heat it. By controlling them in this manner, the moisture trapped in the moisture absorbing layer 36 is released and the air containing the moisture is discharged to the vehicle exterior via the fourth flow path 14.

In the regeneration mode, the control unit 40 may control the second valve 52 so that a part of the air flows into the second flow path 12. By controlling them in this manner, the air becomes constantly flowing through the vehicle air conditioning system, allowing for continuous cooling and heating by the evaporator or other equipment disposed on the downstream side of the fifth flow path 15.

In the regeneration mode, the moisture absorbing layer 36 is preferably heated at a temperature higher than the separating temperature depending on the type of the moisture absorbing layer 36 in order to promote the separation of the moisture trapped by the dehumidifying layer 36. For example, it is more preferable to heat the moisture absorbing layer 36 at 70 to 150° C., even more preferably 80 to 140° C., and still more preferably 90 to 130° C.

### Blowing Mode

The blowing mode is performed when dehumidification or regeneration of the humidity controlling device 30 is not required. In the blowing mode, the control unit 40 controls the second valve 52 so that the air flows into the second flow path 12 and fifth flow path 15 sequentially. Specifically, the first valve 51 is closed and the second valve 52 is opened. By controlling them in this manner, the air flowing in the first flow path 12 can be returned to the vehicle interior via the fifth flow path 13. At this time, cooling or heating may be performed by an evaporator or other equipment disposed on the downstream side of the fifth flow path 15. Therefore, when dehumidification or regeneration of the humidity controlling device 30 is not performed, the load on the ventilation fan 20 can be reduced and power can be conserved.

### Embodiment 2

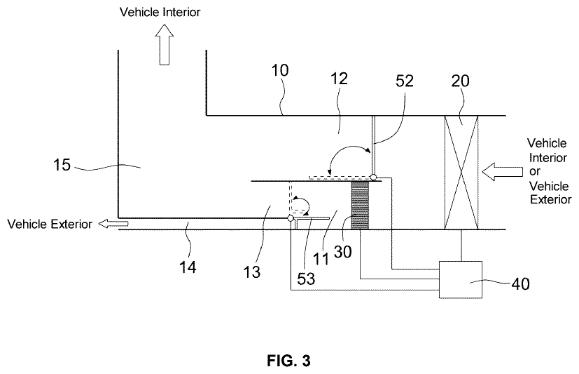

FIG. 3 is an overall schematic configuration view of a vehicle air conditioning system according to Embodiment 2 of the present invention.

As shown in FIG. 3, the vehicle air conditioning system according to Embodiment 2 differs from the vehicle air conditioning system according to Embodiment 1 in that the former does not include the first valve 51. In other words, the vehicle air conditioning system according to Embodiment 2 is basically the same as the vehicle air conditioning system according to Embodiment 1, with the exception that the former does not have the first valve 51.

It should be noted that components with the same numerical numbers as those appearing in the descriptions of the vehicle air conditioning system according to Embodiment 1 of the present invention are the same as the components of the vehicle air conditioning system according to Embodiment 2 of the present invention.

Since the vehicle air conditioning system according to Embodiment 2 of the present invention does not have the first valve 51, the air cannot flow into the second flow path 12 only, but by increasing the opening degree of the second valve 52, the air can flow preferentially into the second flow path 12. Also, the vehicle air conditioning system according to Embodiment 2 of the present invention can simplify the vehicle air conditioning system by omitting the first valve 51. Further, the vehicle air conditioning system according to Embodiment 2 of the present invention can achieve the same effect as that of the the vehicle air conditioning system according to Embodiment 1 of the present invention.

The minimum cross-sectional area of the second flow path 12 is preferably larger than that of the first flow path 11. By controlling the minimum cross-sectional area in this manner, when dehumidification or regeneration of the humidity controlling device 30 is not required, the air can tend to flow preferentially into the second flow path 12, which has a lower pressure loss than the first flow path 11 where the humidity controlling device 30 is disposed.

As used herein, the “minimum cross-sectional area” of each flow path means the area of the cross section orthogonal to the flow direction of the air at the narrowest portion of each flow path.

The minimum cross-sectional area of the fourth flow path 14 is preferably smaller than that of the third flow path 13. Specifically, the minimum cross-sectional area of the third flow path 13 is 4 times or more the minimum cross-sectional area of the fourth flow path 14. By controlling the minimum cross-sectional area in this manner, the flow rate of the air flowing into the first flow path 11 and through the third flow path 13 can be increased during dehumidification, so that the adsorption process can be more efficiently carried out by the humidity controlling device 30. Also, during regeneration of the humidity controlling device 30, the flow rate of the air flowing into the first flow path 11 and into the fourth flow path 14 can be reduced, so that the regeneration process can be efficiently carried out by the humidity controlling device 30.

The upper limit of the minimum cross-sectional area of the third flow path 13 is not particularly limited, but it is preferably 15 times or less than the minimum cross-sectional area of the fourth flow path 14, in terms of reducing the size of the vehicle air conditioning system.

The minimum cross-sectional area of the second flow path 12 is 2 times or more the minimum cross-sectional area of the third flow path 13. By controlling the minimum cross-sectional area in this manner, it is easier to preferentially allow the air to flow into the second flow path 12, which has a smaller pressure loss than the third flow path 13, when dehumidification or regeneration of the humidity conditioning device 30 is not required.

The upper limit of the minimum cross-sectional area of the second flow path 12 is not particularly limited, but it is preferably six times or less the minimum cross-sectional area of the third flow path 13, in terms of reducing the size of the vehicle air conditioning system.

In the air conditioning system according to Embodiment 2 of the present invention, the control unit 40 is electrically connected to the ventilation fan 20, the humidify controlling device 30, and each valve (the second valve 52 and the third valve 53).

The control unit 40 can execute the dehumidification (moisture absorption) mode, the regeneration mode and an air blowing mode. Hereinafter, each of these modes will be described.

### Dehumidification Mode

In the dehumidification mode, the control unit 40 controls the third valve 53 so that the air flows into the first flow path 11, the third flow path 13 and the fifth flow path 15 sequentially. Specifically, the third valve 53 is switched so that the air flows through the third flow path 13 and the air does not flow through the fourth flow path 14. By controlling them in this manner, the air flowing in the first flow path 11 can be dehumidified in the humidity controlling device 30 and returned to the vehicle interior via the third flow path 13 and the fifth flow path 15.

In the dehumidification mode, the control unit 40 may control the second valve 52 so that a part of the air flows into the second flow path 12. Such control can suppress excessive dehumidification, thereby optimizing the humidity of the air in the vehicle interior.

### Regeneration Mode

In the regeneration mode, the control unit 40 controls the third valve 53 so that the air flows into the first flow path 11 and the fourth flow path 14 sequentially. Specifically, the third valve 53 is switched so that the air does not flows through the third flow path 13 and the air flows through the fourth flow path 14. The control unit 40 also applies voltage to the humidity controlling device 30 to heat it. By controlling them in this manner, the moisture trapped in the moisture absorbing layer 36 is released and the air containing the moisture is discharged to the vehicle exterior via the fourth flow path 14.

In the regeneration mode, the control unit 40 may control the second valve 52 so that a part of the air flows into the second flow path 12. By controlling them in this manner, the air becomes constantly flowing through the vehicle air conditioning system, allowing for continuous cooling and heating by the evaporator or other equipment disposed on the downstream side of the fifth flow path 15.

### Blowing Mode

The blowing mode is performed when dehumidification or regeneration of the humidity controlling device 30 is not required. In the blowing mode, the control unit 40 controls the second valve 52 so that the air flows into the second flow path 12 and fifth flow path 15 sequentially. Specifically, the control unit 51 controls the second valve 52 to be opened. By controlling them in this manner, the air flowing in the first flow path 12 can be returned to the vehicle interior via the fifth flow path 13. At this time, cooling or heating may be performed by an evaporator or other equipment disposed on the downstream side of the fifth flow path 15. Therefore, when dehumidification or regeneration of the humidity controlling device 30 is not performed, the load on the ventilation fan 20 can be reduced and power can be conserved.

The features of the vehicle air conditioning system according to Embodiment 2 of the present invention can be combined with the vehicle air conditioning system according to Embodiment 1 of the present invention to the extent that the effects of the present invention are not hindered. For example, the features of the minimum cross-sectional area of each flow path may be applied to the vehicle air conditioning system according to Embodiment 1.

### Description of Reference Numerals

10 air conditioning duct
11 first flow path
12 second flow path
13 third flow path
14 fourth flow path
15 fifth flow path
20 ventilation fan
30 humidity controlling device
31 honeycomb structure
32 outer peripheral wall
33a first end face
33b second end face
34 cell
35 partition wall
36 moisture absorbing layer
37a, 37b electrodes
38 terminal
40 control unit
51 first valve
52 second valve
53 third valve

1. A vehicle air conditioning system, comprising:
an air conditioning duct through which air from a vehicle interior or a vehicle exterior can flow;
a ventilation fan disposed in the air conditioning duct; and
a humidity controlling device comprising: a honeycomb structure having an outer peripheral wall and partition walls disposed on an inner side of the outer peripheral wall, the partition walls defining a plurality of cells, each of the cells extending from a first end face to a second end face to form a flow path for the air;
and a moisture absorbing layer formed on each surface of the partition walls, the humidity controlling device being disposed in the air conditioning duct on a downstream side of the ventilation fan, wherein,
the air conditioning duct is branched on a downstream side of the ventilation fan into a first flow path with the humidity controlling device and a second flow path without the humidity controlling device,
the first flow path is further branched into a third flow path for allowing the air to flow into the vehicle interior, and a fourth flow path for allowing the air to be discharged to the vehicle exterior,
the second flow path is provided with a second valve capable of adjusting an amount of the air flowing therein, and
a branched portion of the third flow path and the fourth flow path is provided with a third valve capable of switching the flow of the air between the third flow path and the fourth flow path.

2. The vehicle air conditioning system according to claim 1, wherein the first flow path is provided with a first valve capable of adjusting an amount of the air flowing therein, on an upstream side of the humidity controlling device.

3. The vehicle air conditioning system according to claim 2, further comprising a control unit capable of controlling the first valve, the second valve, and the third valve.

4. The vehicle air conditioning system according to claim 3, wherein the control unit controls opening degrees of the first valve and the second valve during a moisture adsorption mode and a regeneration mode of the humidity controlling device.

5. The vehicle air conditioning system according to claim 4, wherein, when a flow rate of the air generated by the ventilation fan is 3 m³/min or less, the control unit controls a ratio of the opening degree of the second valve to the opening degree of the first valve to 0.5 or less.

6. The vehicle air conditioning system according to claim 4, wherein, when a flow rate of the air generated by the ventilation fan is more than 3 m³/min, the control unit controls a ratio of the opening degree of the second valve to the opening degree of the first valve to 0.3 or more.

7. The vehicle air conditioning system according to claim 1, wherein a minimum cross-sectional area of the second flow path is larger than that of the first flow path, and the minimum cross-sectional area of the fourth flow path is smaller than that of the third flow path.

8. The vehicle air conditioning system according to claim 7, wherein the minimum cross-sectional area of the second flow path is 2 times or more the minimum cross-sectional area of the third flow path.

9. The vehicle air conditioning system according to claim 7, wherein the minimum cross-sectional area of the first flow path is 4 times or more the minimum cross-sectional area of the second flow path.

10. The vehicle air conditioning system according to claim 1, wherein at least the partition walls of the honeycomb structure are made of a material having a PTC property.

11. The vehicle air conditioning system according to claim 1, wherein the humidity controlling device further comprises a pair of electrodes provided on the first end face and the second end face of the honeycomb structure, or on the outer peripheral wall parallel to an extending direction of the cells of the honeycomb structure.
